(19) United States
(12) Patent Application Publication
(10) Pub. No.: US 2013/0009774 A1
(43) Pub. Date: Jan. 10, 2013

(54) REMINDER METHOD & SYSTEM FOR MERCHANDISE RETURNS

(76) Inventor: Anton Sabeta, Toronto (CA)

(21) Appl. No.: 13/467,016

(22) Filed: May 8, 2012

Related U.S. Application Data
(60) Provisional application No. 61/483,706, filed on May 8, 2011.

(51) Int. Cl. G08B 21/00

(52) U.S. Cl. 340/540

(57) ABSTRACT

A reminder method and system for merchandise returns or exchange within a predetermined time post-purchase.

### CROSS-REFERENCE TO RELATED APPLICATIONS

This application claims the benefit of priority to U.S. Provisional Application Ser. No. 61/483,706 filed May 8, 2011.

### FIELD OF INVENTION

The present invention relates to merchandise return, more specifically it relates to a reminder method and system for merchandise returns within a predetermined time post-purchase.

### BACKGROUND OF THE INVENTION

Merchandise items are often returned to the merchant for a variety of reasons, such as, a manufacturing defect, ill-fitting, negative feedback, buyer's remorse, unwanted gift, fraudulent returns (wardrobing), and non-satisfaction. Many merchants have return policies that stipulate the conditions for accepting a return. An exemplary return policy for one retailer dictates: “Our store WILL NOT accept any returns or exchanged items: (1) Without a receipt. (2) If the goods are not in their ORIGINAL CONDITION. (3) If any of the tags have been removed totally and then re-attached. (4) If a garment has been used or worn. (5) If a garment has been washed. (6) If a garment has been used or worn, and or has foundation marks, deodorant marks or smells of perfume/after-shave/deodorant. (7) If the garment was purchased more than 14 days before the date of the return.”

Therefore, the onus is on the customer to keep the receipt for the duration of the return period in order to return the merchandise within that period. However, it is not uncommon for the receipt to get misplaced, damaged, or the ink simply fades away such that it is illegible. In addition, one receipt is often issued for a plurality of items, all of which may have varying return periods, for example, the return period for consumer electronics may be 15 days, while the return period for an item of clothing is 30 days. Therefore it is up to the customer to scrutinize the receipt and extract the relevant time limits for each item. Inevitably, the return deadline is often simply forgotten or miscalculated, thereby forfeiting an opportunity for a refund or exchange.

It is an object of the present invention to mitigate or obviate at least one of the above-mentioned disadvantages.

### SUMMARY OF THE INVENTION

In one of its aspects, there is provided a reminder method for merchandise returns within a predetermined time post-purchase, the method having the steps of:

receiving a receipt associated with at least one article of merchandise;

analyzing said receipt;

recognizing at least one merchandise code within said receipt;

recognizing a date of purchase of said at least one article of merchandise;

recognizing a merchant's identity;

determining a return period for said at least one article of merchandise based on said merchant's return policy;

providing at least one alert associated with said return period.

In another of its aspects, there is provided a non-transitory computer readable medium having programmed instructions executable by a microprocessor to cause the microprocessor to provide an alerting method for merchandise return within a predetermined time post-purchase, the method comprising the steps of:

receiving a receipt associated with at least one article of merchandise;

analyzing said receipt;

recognizing at least one merchandise code within said receipt;

recognizing a date of purchase of said at least one article of merchandise;

recognizing a merchant's identity;

determining a return period for said at least one article of merchandise based on said merchant's return policy;

providing at least one alert associated with said return period.

In another of its aspects, there is provide a device comprising:

a non-transitory computer readable medium having programmed instructions executable by a microprocessor to cause the microprocessor to process a receipt having data related to an item of merchandise, and extract said merchandise data;

a database having merchant data, said merchant data comprising said item of merchandise data and associated return policy data; and

a return reminder engine for receiving said merchandise data, merchant data and return policy data and determine a date of purchase and elapsed time post-purchase, and determine whether said item of merchandise is eligible for return based on said return policy data; and providing at least one alert associated with said item of merchandise based on said return policy data.

Advantageously, merchandise may be successfully returned to the merchant within the prescribed return period, even without an original receipt, depending on the merchant's return policy.

### BRIEF DESCRIPTION OF THE DRAWINGS

Several preferred embodiments of the present invention will now be described, by way of example only, with reference to the appended drawings in which:

FIG. 1 shows an exemplary system for merchandise return reminders;

FIG. 2a shows exemplary steps for a merchandise return reminder method; and

FIG. 2b shows exemplary steps for a merchandise return reminder method, in another embodiment;

FIG. 3a shows an exemplary user interface for capturing an image of a receipt with an electronic device;

FIG. 3b shows an exemplary user interface with the receipt being processed;

FIG. 3c shows an exemplary user interface for verifying details of the merchandise item;

FIG. 3d shows an exemplary user interface for selecting the reminder frequency;

FIG. 3e shows an exemplary user interface displaying a plurality of reminders;

FIG. 3f shows an exemplary user interface displaying a calendar application with a plurality of reminders;

FIG. 3g shows an exemplary user interface displaying details of a reminder for a merchandise item;

FIG. 3h shows an exemplary user interface displaying details of a merchant return policy;

FIG. 3i shows an exemplary user interface displaying a pop-up reminder or alert; and

FIG. 3j shows an exemplary user interface displaying a location of the merchant for merchandise return.

### DESCRIPTION OF THE PREFERRED EMBODIMENTS

The detailed description of exemplary embodiments of the invention herein makes reference to the accompanying block diagrams, schematic diagrams, and flowcharts, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention may be described herein in terms of block diagrams, screen shots and flowcharts, optional selections and various processing steps. Such functional blocks may be realized by any number of hardware and/or software components configured to perform to specified functions. For example, the present invention may employ various integrated circuit components (e.g., memory) elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

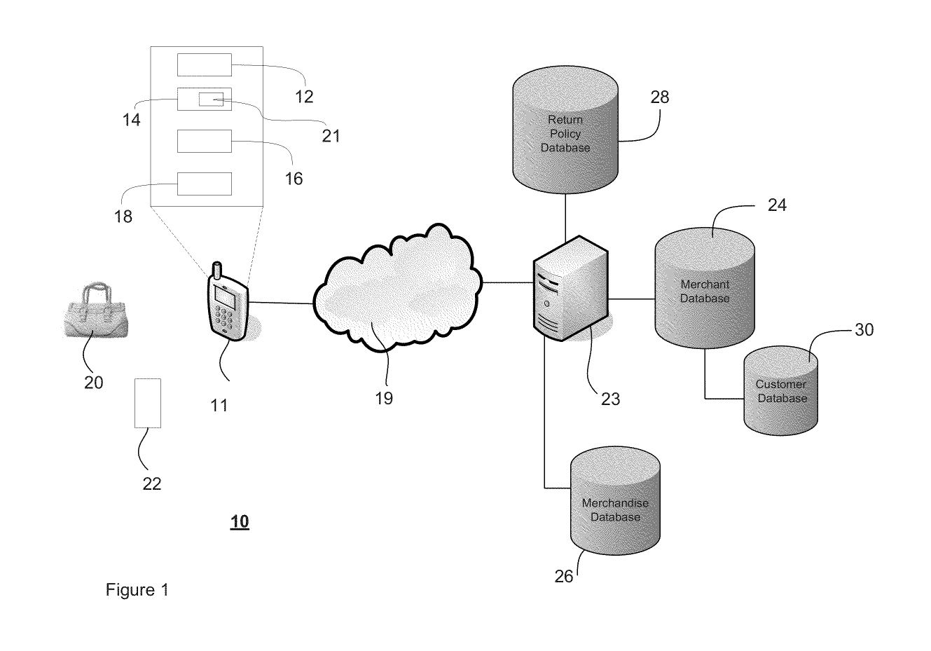

FIG. 1 is a schematic view of an illustrative system 10 for providing merchandise return reminders. The system 10 comprises an electronic device 11 which can include control circuitry 12, storage 14, input/output (“I/O”) circuitry 16, and communications circuitry 18.

Electronic device 11 can include any suitable type of electronic device. For example, electronic device 11 can include a portable electronic device, a smartphone (e.g., an iPhone™ made available by Apple Inc., Cupertino, U.S.A.), a personal data assistant (“PDA”), a cellular telephone, a handheld gaming device, or a digital camera. As another example, electronic device 11 can include a larger portable electronic device, such as a tablet computer or a laptop computer. As yet another example, electronic device 11 can include a substantially fixed electronic device, such as a desktop computer.

Control circuitry 12 can include any processing circuitry or processor operative to control the operations and performance of electronic device 11. For example, control circuitry 12 can be used to run operating system applications, firmware applications, media playback applications, media editing applications, or any other application. In some embodiments, control circuitry 12 can drive a display and process inputs received from a user interface.

Storage 14 can include, for example, one or more storage mediums including a hard-drive, solid state drive, flash memory, permanent memory such as ROM, any other suitable type of storage component, or any combination thereof. Storage 14 can store, for example, media data (e.g., music and video files), application data (e.g., for implementing functions on electronic device 11), firmware, user preference information data, authentication information (e.g. libraries of data associated with authorized users), transaction information data (e.g., information such as credit card information), wireless connection information data (e.g., information that can enable electronic device 11 to establish a wireless connection), contact information data (e.g., telephone numbers and email addresses), calendar information data, and any other suitable data or any combination thereof. Instructions for programs or other executables can be pre-loaded into a programmable memory that is accessible to the processor and/or can be dynamically loaded into/from one or more volatile (e.g., RAM, cache, etc.) and/or non-volatile (e.g., a hard drive, optical disk, compact disk (CD), digital video disk (DVD), magnetic disk, magnetic tape, internal hard drive, external hard drive, random access memory (RAM), redundant array of independent disks (RAID), IC memory card, flash memory, or removable memory device) memory elements communicatively coupled to the control circuitry 12.

I/O circuitry 16 can be operative to convert (and encode/decode, if necessary) analog signals and other signals into digital data. In some embodiments, I/O circuitry 16 can also convert digital data into any other type of signal, and vice-versa. For example, I/O circuitry 16 can receive and convert physical contact inputs (e.g., from a multi-touch screen), physical movements (e.g., from a mouse or sensor), analog audio signals (e.g., from a microphone), or any other input. The digital data can be provided to and received from control circuitry 12, storage 14, or any other component of electronic device 11. Although I/O circuitry 16 is illustrated in FIG. 1 as a single component of electronic device 11, several instances of I/O circuitry 16 can be included in electronic device 11.

Electronic device 11 can include any suitable interface or component for allowing a user to provide inputs to I/O circuitry 16. For example, electronic device 11 can include any suitable input mechanism, such as for example, a button, keypad, dial, a click wheel, or a touch screen. In some embodiments, electronic device 11 can include a capacitive sensing mechanism, or a multi-touch capacitive sensing mechanism. The device 11 can include an image capture device, such as a camera.

In some embodiments, electronic device 11 can include specialized output circuitry associated with output devices such as, for example, one or more audio outputs. The audio output can include one or more speakers built into electronic device 11, or an audio component that is remotely coupled to electronic device 11 (e.g., a headset, headphones or earbuds that can be coupled to communications device with a wire or wirelessly).

In some embodiments, I/O circuitry 16 can include display circuitry (e.g., a screen or projection system) for providing a display visible to the user. For example, the display circuitry can include a screen (e.g., an LCD screen) that is incorporated in electronics device 11. As another example, the display circuitry can include a movable display or a projecting system for providing a display of content on a surface remote from electronic device 11 (e.g., a video projector). In some embodiments, the display circuitry can include a coder/decoder (CODEC) to convert digital media data into analog signals. For example, the display circuitry (or other appropriate circuitry within electronic device 11) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 12. Alternatively, the display circuitry can be operative to provide instructions to a remote display.

Communications circuitry 18 can include any suitable communications circuitry operative to connect to a communications network 19 and to transmit communications (e.g., voice or data) from electronic device 11 to other devices within the communications network. Communications circuitry 18 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, communications circuitry 18 can be operative to create a communications network using any suitable communications protocol. For example, communications circuitry 18 can create a short-range communications network using a short-range communications protocol to connect to other devices. For example, communications circuitry 18 can be operative to create a local communications network using the Bluetooth® protocol to couple electronic device 11 with a Bluetooth® headset.

Electronic device 11 can include one more instances of communications circuitry 18 for simultaneously performing several communications operations using different communications networks, although only one is shown in FIG. 1 to avoid overcomplicating the drawing. For example, electronic device 11 can include a first instance of communications circuitry 18 for communicating over a cellular network, and a second instance of communications circuitry 18 for communicating over Wi-Fi or using Bluetooth®. In some embodiments, the same instance of communications circuitry 18 can be operative to provide for communications over several communications networks.

In some embodiments, electronic device 11 can be coupled a host device for data transfers, synching the communications device, software or firmware updates, providing performance information to a remote source or performing any other suitable operation that can require electronic device 11 to be coupled to a host device. Several electronic devices 10 can be coupled to a single host device using the host device as a server. Alternatively or additionally, electronic device 11 can be coupled to several host devices (e.g., for each of the plurality of the host devices to serve as a backup for data stored in electronic device 11).

In one exemplary embodiment, an electronic device 11 provides a merchandise return reminder method which provide alerts to a user, the alerts being associated with merchandise items 20 purchased from a merchant, a shop (e.g., a physical store, an on-line store, or both), or to any other entity suitable for providing merchandise items 20 to a user. The device 11 thus includes a return reminder engine 21 having instructions stored in storage 14 for execution by the control circuitry 12 to provide at least one alert. Typically, a sales receipt 22 is issued at the point of sale and is normally printed on paper or other suitable medium. The receipt 22 may include the merchant ID/data, store ID, store customer service representative data/ID, the consumer ID/data, markdown data, inventory data, SKU, URI associated with merchant or merchandise item 20 or 3^{rd} party merchant or advertisement, advertisement or promotional information, contest information, return policy, point of sale data, date and time, location data, item(s) purchased, item price (for each individual item), subtotal, shipping charges (if applicable), tax, discounts (if applicable), grand total, payment method, payment amount, and change returned, truncated credit or debit card information, rebates. This information is received at the remote server/database location and stored in the consumer/member's individual account for future use/reference. The receipt may also be a gift receipt with at least one of the above noted pieces of information. Accordingly, the return reminder engine 21 receives data from a merchant database 24, a merchandise database 26 and a return policy database 28.

The merchandise 20 may include any articles that are eligible for return or exchange to a merchant, such as, but is not limited to, items of clothing, footwear, eyewear, headgear, garments, jewellery, accessories, handbags, purses, timepieces, computing devices, consumer electronics and associated accessories, furniture, appliances, recreational toys, dolls, personal hygiene products, cosmetics, fragrances, media products, print media, books, floor covers, linens, blankets, bedding, consumables, food, drinks, water recreational products, vehicles (motorized or non-motorized) products and accessories and parts, pet products & accessories, household items, yard or garden items, tools, power tools, paint, lumber, construction products, light sources, and so forth. Accordingly, the articles 20 may be returned for a refund, exchange or store credit.

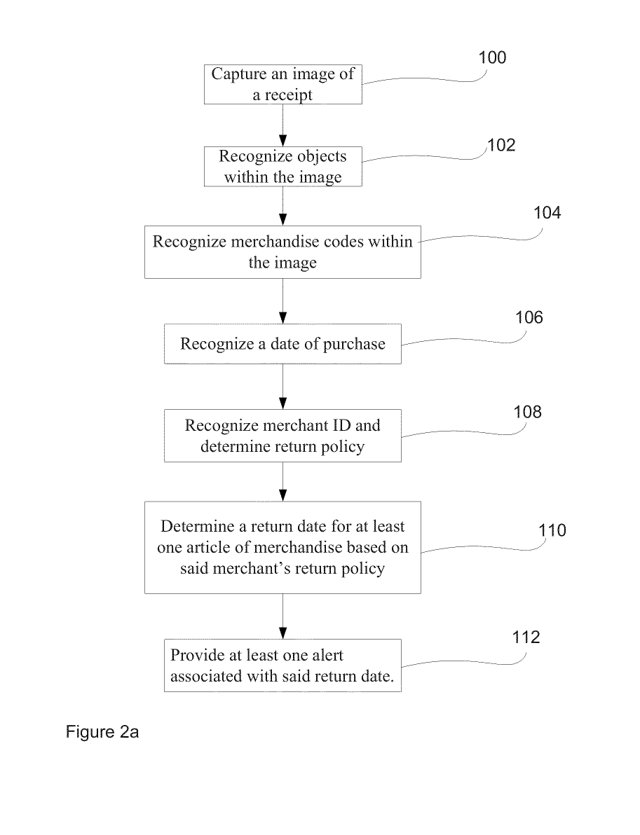

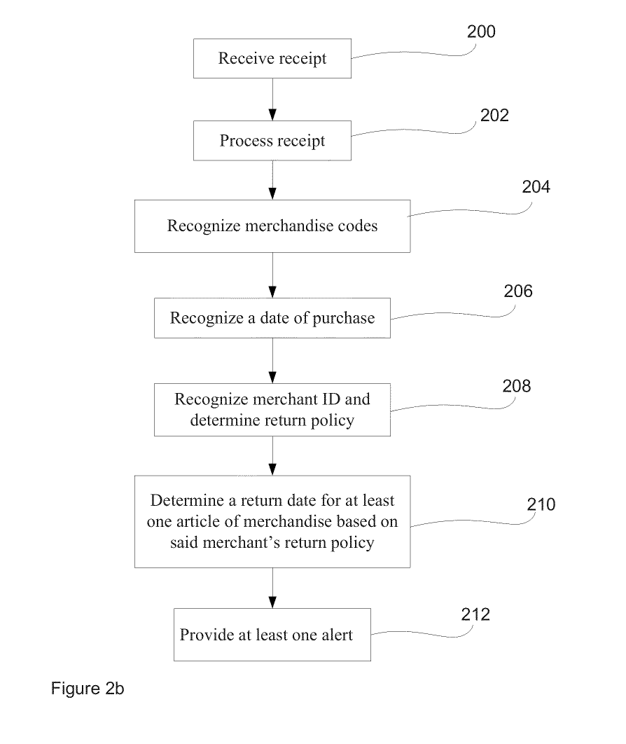

FIG. 2a shows the steps for a reminder method for merchandise returns within a predetermined time post-purchase, using data extracted from a receipt 22 on printed medium, such as paper. In step 100, the receipt 22 is captured by a camera associated with the device 11 and stored in storage 14.

In step 102, the objects within the captured image of the receipt 22 are recognized using, for example, an optical character recognition (OCR) program associated with the device 11. The objects may include text, images, logos, a barcode or optical pattern. The objects may include item description, purchase date, return period, return policy, merchant data/indicia/logo, SKU, UPC-A, UPC-E, EAN-8, EAN-13, Code 39, GTIN, QR code, etc. The optical pattern can, for example, directly include the enhanced information or can include a serial number or other identifying information allowing the integrated application to access at least one database associated with the merchandise item 20. The database may be on the device 11 or may be coupled to another computing entity or server 23, such as a remote merchant database 24. The merchant database 24 may include any of the following information, but not limited to, description of the merchandise, pricing data, sale or markdown data, gift item, inventory data, SKU, merchant data, customer data, purchased merchandise data, returned merchandise data, statistical data, or a combination thereof.

An image of the merchandise item 20 may be acquired from a database having product data associated with the merchandise code, such as a merchandise database 26 (step 104). The merchandise codes may include any of a SKU, UPC-A, UPC-E, EAN-8, EAN-13, Code 39, GTIN, and QR code. The merchandise database 26, or a portion thereof, may be on said device 11, or may be on a 3^{rd} party database for remote retrieval. Alternatively, the image of the item 20 may captured by the camera of device 11.

The device 11 then recognizes the date of purchase within the image and recognizes the merchant's identity from the characters, text, logo or associated QR code (step 106). Using the merchant's name or ID, the return policy for at least one article of merchandise 20 on the receipt 22 is determined (step 108), and a corresponding return date is determined (step 110). Therefore, the device 11 recognizes any of the above-noted receipt data and exports that data into data fields corresponding thereto. Subsequently, at least one alert associated with said return date is provided, the alert is calculated using a timer which counts down from the return date or counts up to the return date (step 112). The alert is provided to a calendar application program running on the device 11, such as Microsoft Outlook™, from Microsoft Corporation, Redmond, Wash., U.S.A. or Google Calendar™ from Google Inc., Mountain View, Calif., U.S.A. or other online calendar. The alerts therefore serve to remind the user of the number of days remaining before the merchandise item 20 is ineligible for return to the merchant. Exemplary alerts may include: “Return PRADA™ Purse [Beige, SKU 002022044] by May 8, 2011] or “2 days remaining to return PRADA™ Purse [Beige, SKU 002022044]. The alerts are issued periodically until the return date, and can be user defined. The user may be presented with an option to ignore the alert, set a further reminder or delete the reminder if the merchandise item 20 will not be returned or is no longer ineligible for return, for example, if it has been worn. The user can also set further user-defined reminders. Should the user decide to return an eligible item 20, then via the device 11 provides the location and details (phone no./hours of operation, URI, returns instructions etc.) of the nearest store accepting returns, and using the device 11 ‘s geo-location data provide directions.

In another exemplary embodiment, the receipt 22 is electronic, such that receipt information is readily available for extraction into the associated data fields. The electronic receipt 22 may include any of the above-note information, including meta-data, at least one URI associated with merchant or merchandise item 20, images, videos associated with said merchandise item 20 or advertisements.

FIG. 2b shows the steps for a reminder method for merchandise returns within a predetermined time post-purchase, using data extracted from an electronic receipt 22. In step 200, the receipt 22 is received for processing.

In step 202, data from the receipt 22 is extracted. The data may include a description of the merchandise, purchase date, return period, return policy, merchant data/indicia/logo, SKU, UPC-A, UPC-E, EAN-8, EAN-13, Code 39, GTIN, QR code, etc. The optical pattern can, for example, include the enhanced information or can include a serial number or other identifying information allowing the integrated application to access at least one database associated with the merchandise item 20. The database may be on the device 11 or may be coupled to another computing entity or server 23, such as a remote merchant database 24. The merchant database 24 may include any of the following information, but not limited to, description of the merchandise, pricing data, sale or markdown data, gift item, inventory data, SKU, merchant data, customer data, purchased merchandise data, returned merchandise data, statistical data, or a combination thereof. An image of the merchandise item 20 may be acquired from a database having product data associated with the merchandise code, such as a merchandise database 26 (step 204). The merchandise codes may include any of a SKU, UPC-A, UPC-E, EAN-8, EAN-13, Code 39, GTIN, and QR code. The merchandise database 26, or a portion thereof, may be on said device 11, or may be on a 3^{rd} party database for remote retrieval. Alternatively, the image of the item 20 may captured by the camera of device 11.

In step 206, the device 11 recognizes the date of purchase within the image and recognizes the merchant's identity from the characters, text, logo or associated QR code. Using the merchant's name or ID, the return policy for at least one article of merchandise 20 on the receipt 22 is determined (step 208), and a corresponding return date is determined (step 210). Therefore, the device 11 recognizes any of the above-noted receipt data and exports that data into data fields corresponding thereto. Subsequently, at least one alert associated with said return date is provided, the alert is calculated using a timer which counts down from the return date or counts up to the return date (step 212). The alert is provided to a calendar application program running on the device 11, such as Microsoft Outlook™, from Microsoft Corporation, Redmond, Wash., U.S.A. or Google Calendar™ from Google Inc., Mountain View, Calif., U.S.A. or other online calendar. The alerts therefore serve to remind the user of the number of days remaining before the merchandise item 20 is ineligible for return to the merchant. Exemplary alerts may include: “Return PRADA™ Purse [Beige, SKU 002022044] by May 8, 2011] or “2 days remaining to return PRADA™ Purse [Beige, SKU 002022044]. The alerts are issued periodically until the return date or can be user defined. The user may be presented with an option to ignore the alert, set a further reminder or delete the reminder if the merchandise item 20 will not be returned or is no longer ineligible for return, for example, if it has been worn. The user can also set further user-defined reminders. Should the user decide to return an eligible item 20, then via the device 11 provides the location and details (phone no./hours of operation, URI, returns instructions etc.) of the nearest store accepting returns, and using the device 11 ‘s geo-location data provide directions.

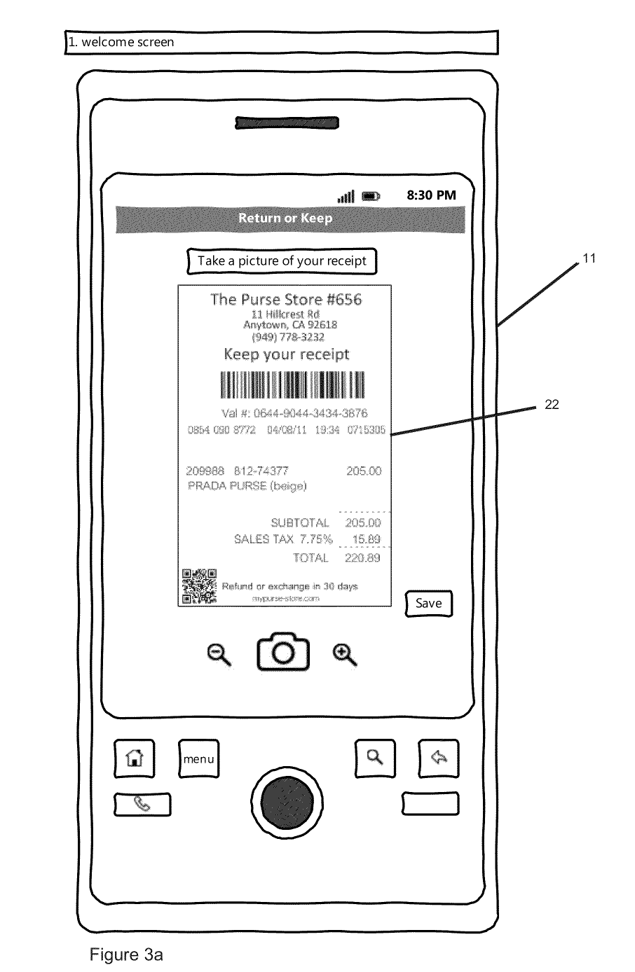

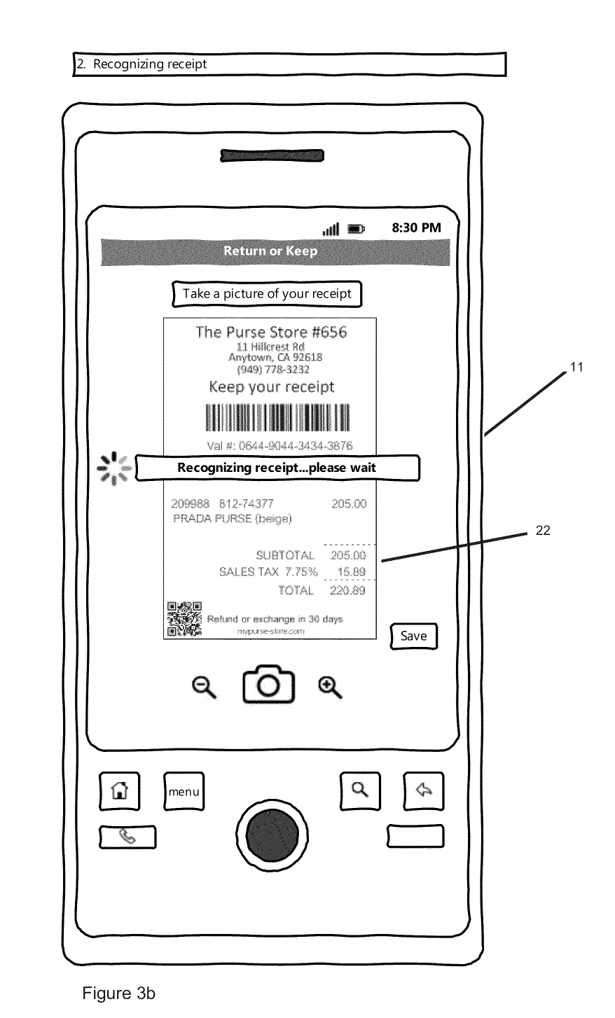

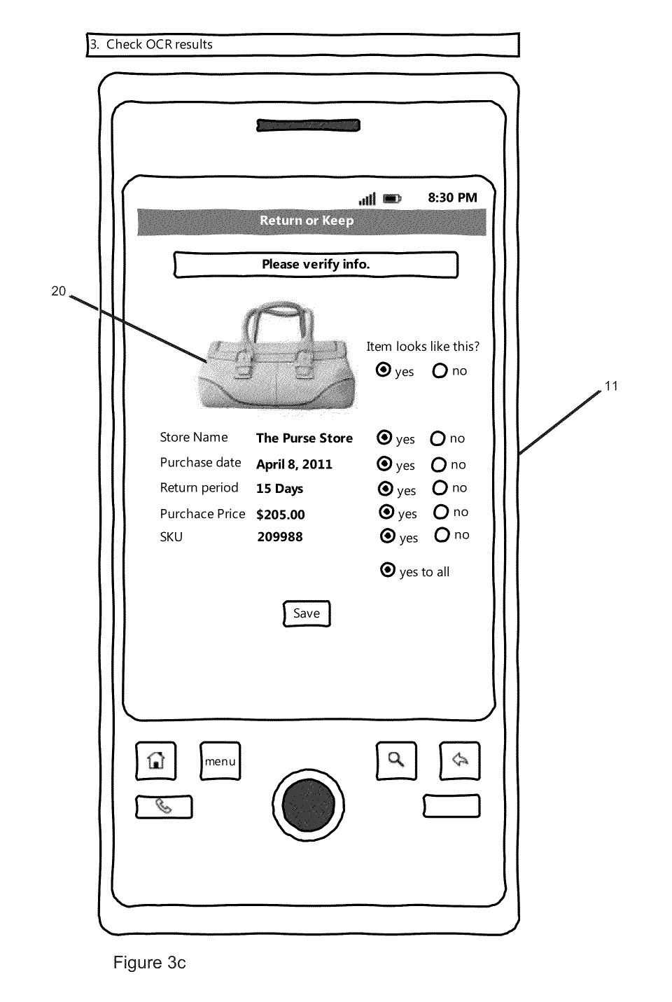

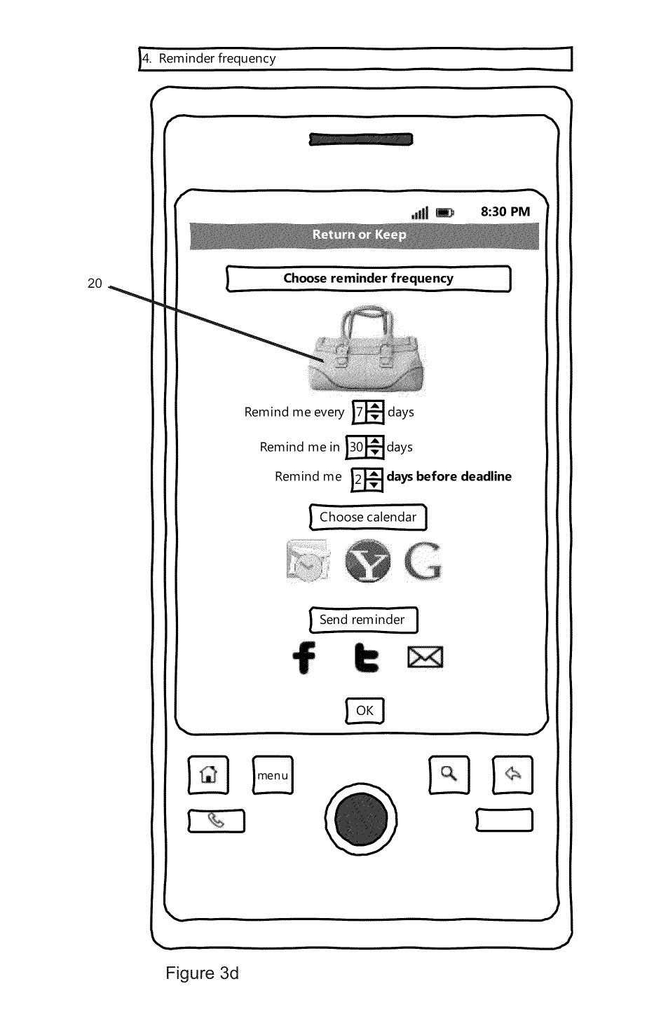

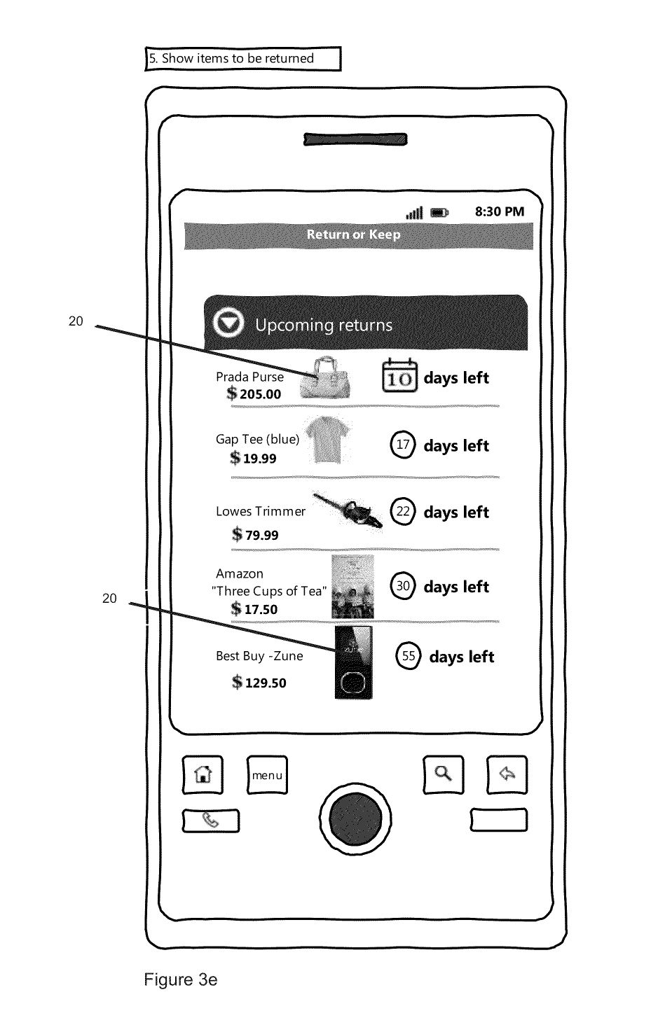

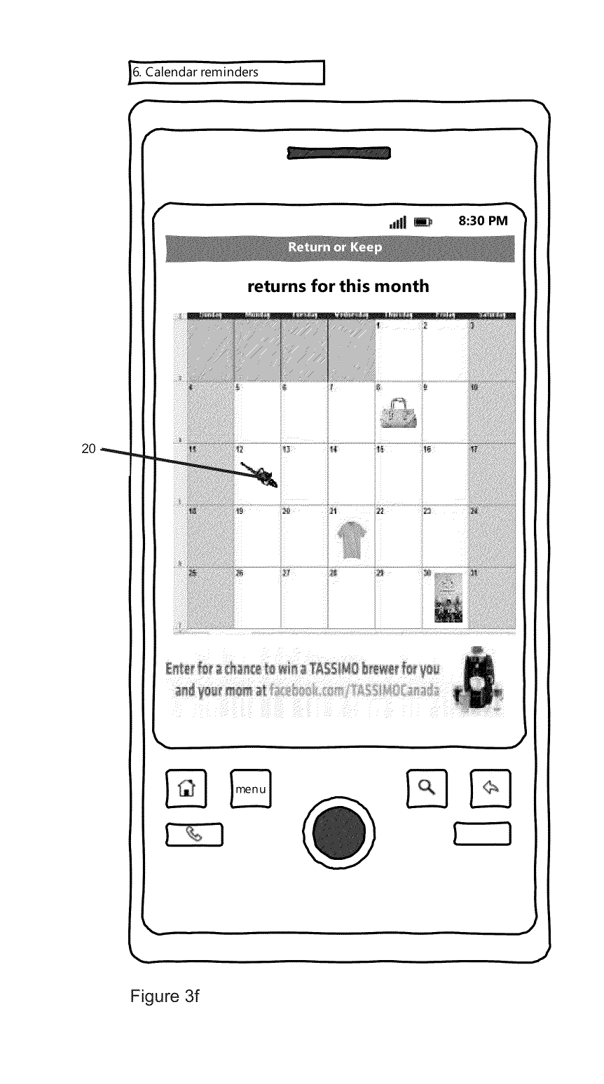

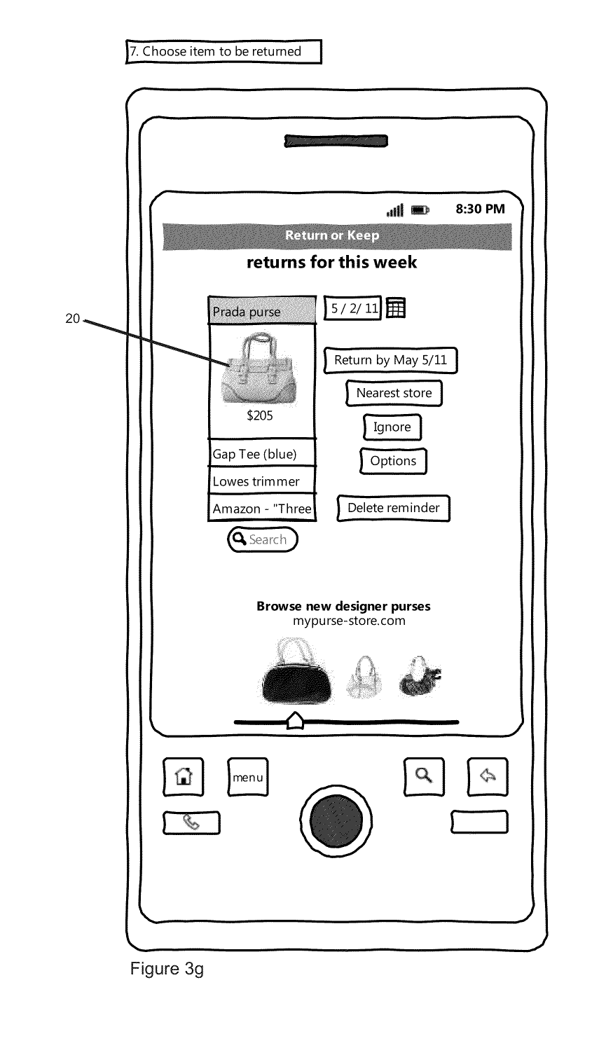

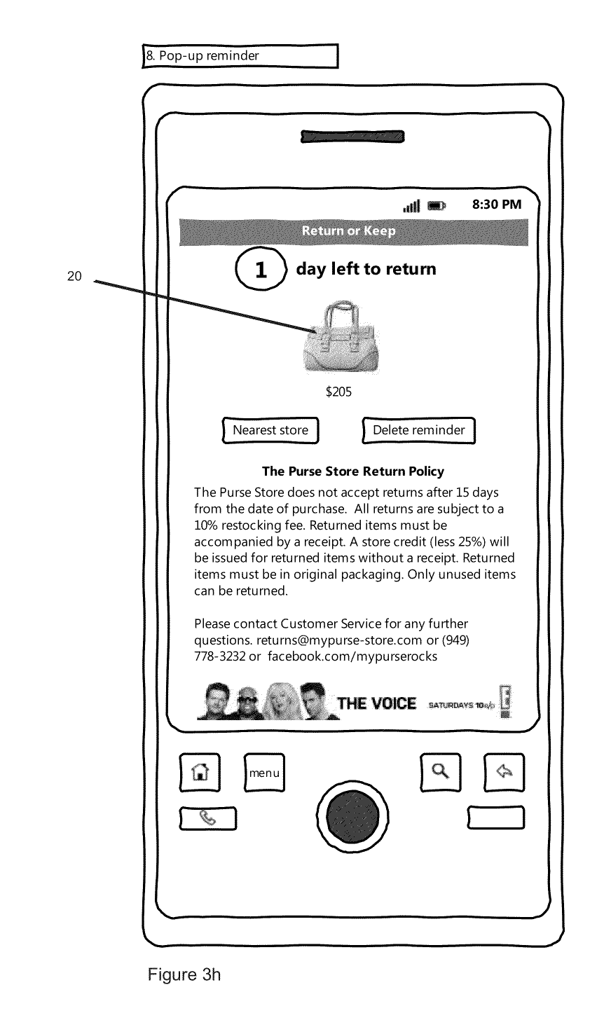

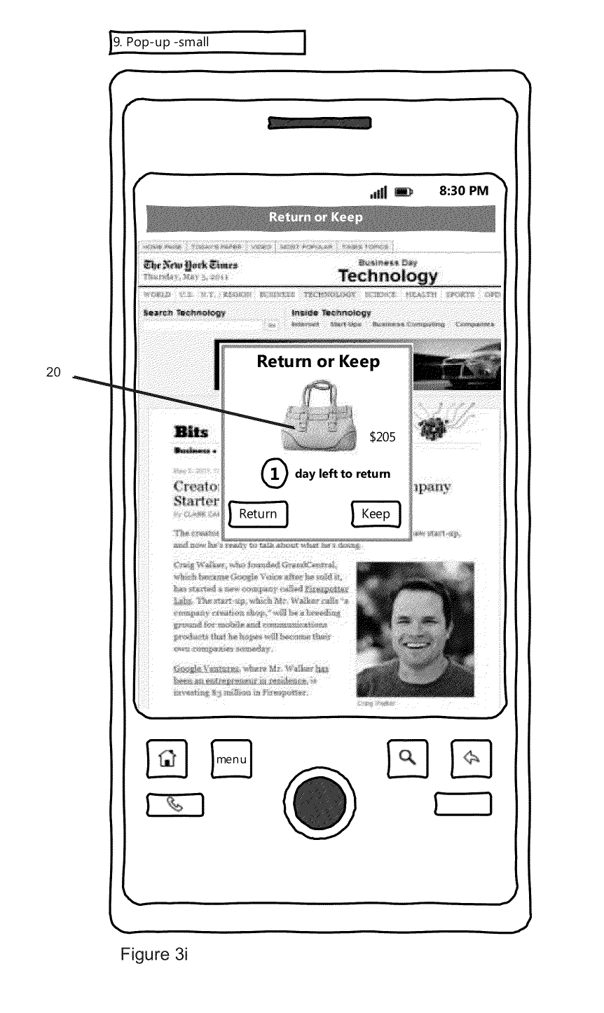

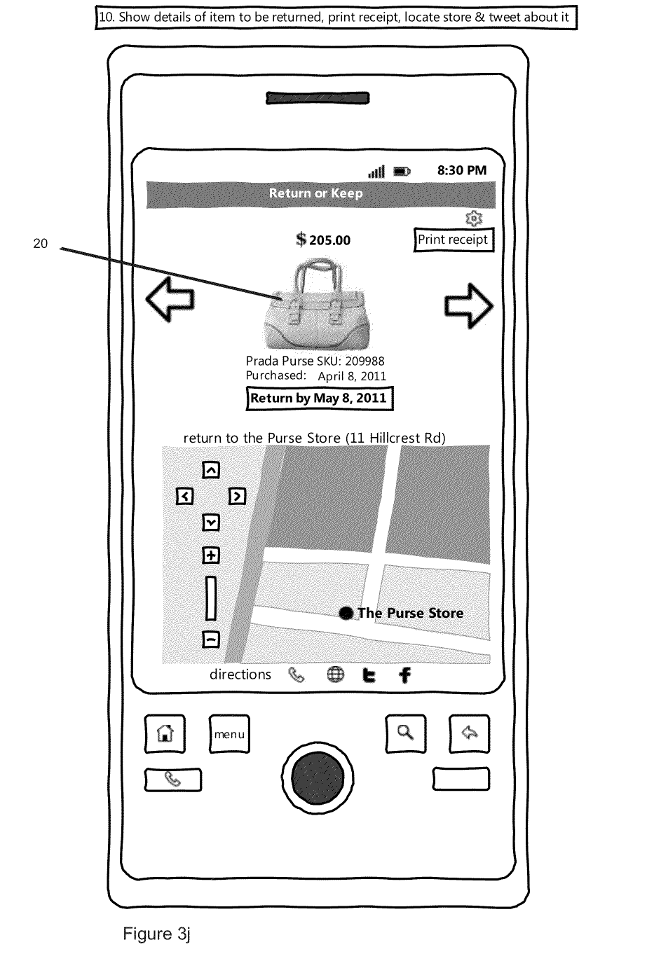

Exemplary interfaces associated with the steps of FIG. 2a are shown in FIGS. 3a to 3j. Although FIGS. 3a to 3j pertain to a reminder method steps using data from a receipt 22 on printed medium, the reminder method steps using data from an electronic receipt 22 comprises similar interfaces with the exception that there is no requirement to capture an image of the receipt 22 in order to recognize objects thereon.

In another exemplary embodiment, the device 11 recognizes and determines at least one merchandise item 20 description from the objects on the receipt 22, such that a receipt 22 with multiple merchandise may give rise a multiple alerts since different merchandise items 20 may have different return policies, hence different return dates. For example, consumer electronic devices, such as gaming consoles, may have a 14 day return period, while shoes may have a 30 day return period. The return policy for an item of merchandise 20 may be based on a category, e.g. clothing or consumer electronics, or it may be based on the item specific identity, such as a SKU, UPC-A, UPC-E, EAN-8, EAN-13, Code 39, GTIN, or QR code.

In another exemplary embodiment, each alert may include an image of the actual merchandise item 20 or product. As described above, the image may be acquired from a database having product data associated with the merchandise code, URI, or can be captured by the camera of device 11.

In another exemplary embodiment, each alert may include advisories or warnings such as restocking fees associated with the return, or issuance of store credit only when merchandise is returned after beyond the prescribed return period or within the return period.

In another exemplary embodiment, the alerts are converted into audible signals that can be heard via the device's speakers or ear buds. For example, the alerts may override the audio of other media that may be playing on the device, such as music or a video.

In another exemplary embodiment, each alert may include advertisements for items or services that may be of interest to the user. For example, the advertisements may be related to the merchandise being returned.

In another exemplary embodiment, each alert may include a questionnaire or survey related to the merchandise being returned, such as reasons for returning the merchandise. The answers to the questionnaire or survey are then automatically sent to the merchant.

In another exemplary embodiment, the device 11 may be coupled to a network 19, and exchanges data with at least one computing entity 23 via the network 19. The computing entity 23 may include the return reminder engine 21, the return policy database 28, the merchant database 24 and the merchandise database 26. Accordingly, the computing entity 23 processes a receipt 22, such as an electronic receipt 22 received from a merchant or a point of sale, and provides the alerts to the device 11 or pushes alerts to the device 11. The alerts may be integrated with a scheduling or calendar application. As an example, the electronic receipt 22 may be issued upon completion of a purchase online, or from a register directly to the remote computing entity, along with the customer details, such as from a customer database 30. As such, the electronic receipt 22 is associated with the customer and alerts are provided to the customer, as discussed above. The remote computing entity 23 may be operated by the merchant or a 3^{rd} party. Alternatively, the electronic receipt 22 is sent to the customer electronically, via email, SMS, webpage, ftp, and so forth.

In another exemplary embodiment, the device 11 may be coupled to a network 19, and exchanges data with at least one computing entity 23 via the network 19. The computing entity 23 may include the return reminder engine 21, the return policy database 28, the merchant database 24 and the merchandise database 26, such that the device 11 provides a receipt 22 to said computing entity and the subsequently the computing entity provides the alerts to the device 11 or pushes alerts to the device 11. The remote computing entity 23 may be operated by the merchant or a 3^{rd} party. The alerts may be integrated with a scheduling or calendar application.

In another embodiment, the device 11 uses an integrated or accessible mapping application to provide a map, direction, to the nearest store. For example, when in the vicinity of a store, using the device 11 geo-location data, the application checks whether there are any items from the nearby store that need to be returned, and alerts the user accordingly.

In another exemplary embodiment, the alerts are issued as an email, SMS/text message, voicemail, URI, or as webpage.

In another exemplary embodiment, the alerts are provided to a social networking site user page, such as Facebook™ or Twitter™. For example, individuals accessing these pages may elect to buy the merchandise from the user rather than the user returning the item to the store and incurring a re-stocking fee, or when the return period has elapsed and the item cannot be returned or exchanged. Users may also exchange items or barter among each other.

In another exemplary embodiment, the alerts are provided to a 3^{rd} party via any one of the above-noted alerting methods. The 3^{rd} party may include, but is not limited to, a parent, guardian, caregiver, friend, group of individuals, an organization or an agency.

In another exemplary embodiment, the merchandise item 20 includes a hang tag with barcode or QR code associated with the article of merchandise 20.

In another exemplary embodiment, the merchandise item 20 hang tag includes an RFID tag associated with the article of merchandise 20.

In another exemplary embodiment, any one of a UPC-A, UPC-E, EAN-8, EAN-13, Code 39, GTIN, QR code, is associated or printed on the merchandise item 20.

In another exemplary embodiment, the RFID tag is associated or embedded with merchandise item 20.

In another exemplary embodiment, the device 11 includes a barcode scanner or an RFID reader coupled thereto acquire receipt information or merchandise information from the hang tag or merchandise item 20.

In another exemplary embodiment, the hang tag includes a sensor associated with the merchandise item 20.

In another exemplary embodiment, a Micro-Electro-Mechanical Systems (MEMS) device is associated with the hangtag or with the merchandise item 20. The MEMS device having microelectronic integrated circuit which can sense the environment via sensors which gather information from the environment through measuring mechanical, thermal, biological, chemical, optical, and magnetic phenomena, among others, as stated above.

In another exemplary embodiment, a user can retrieve a merchant's return policy pertaining to a particular merchandise item 20 from a database having data for a plurality of merchants.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A reminder method for merchandise returns within a predetermined time post-purchase, the method having the steps of:
receiving a receipt associated with at least one article of merchandise;
analyzing said receipt;
recognizing at least one merchandise code within said receipt;
recognizing a date of purchase of said at least one article of merchandise;
recognizing a merchant's identity;
determining a return period for said at least one article of merchandise based on said merchant's return policy;
providing at least one alert associated with said return period.

2. The method of claim 1 wherein said merchandise code is at least one of a SKU, UPC-A, UPC-E, EAN-8, EAN-13, GTIN, Code 39 and QR code.

3. The method of claim 1 wherein said return policy comprises data pertaining to said return period associated with at least one article of merchandise corresponding to said merchant identity.

4. The method of claim 3 wherein said return policy is retrieved from at least one of said merchant, a database associated with said merchant and a database having a plurality of merchant data following said recognition of said merchant identity.

5. The method of claim 4 wherein said return policy for each of said article is based on said merchandise code.

6. The method of claim 5 wherein said alert is associated with an image of said article of merchandise.

7. The method of claim 6 wherein said image of said article of merchandise is retrieved remotely based on at least of said merchandise code.

8. The method of claim 7 wherein said image of said article of merchandise is captured locally.

9. The method of claim 8 wherein a URI is associated with said article of merchandise.

10. The method of claim 1 wherein said receipt comprises any of the following: date of purchase, merchant data, article data, time data, location data, inventory data, SKU, UPC-A, UPC-E, EAN-8, EAN-13, Code 39, GTIN, QR code method of payment, customer data, salesperson data, point of sale data.

11. The method of claim 1 wherein said alert is associated with a calendaring application program.

12. The method of claim 1 comprising the further step of calculating elapsed time post purchase to determine whether said calculated said item of merchandise is eligible for return in accordance with said return policy.

13. The method of claim 1 wherein said alert is user-defined.

14. The method of claim 10 wherein said receipt is an image captured of print matter associated with at least one article of merchandise, wherein said image comprises recognizable objects.

15. The method of claim 14 wherein said recognizable objects are textual or non-textual.

16. The method of claim 10 wherein said receipt is electronic.

17. A non-transitory computer readable medium having programmed instructions executable by a microprocessor to cause the microprocessor to provide an alerting method for merchandise return within a predetermined time post-purchase, the method comprising the steps of:
receiving a receipt associated with at least one article of merchandise;
analyzing said receipt;
recognizing at least one merchandise code within said receipt;
recognizing a date of purchase of said at least one article of merchandise;
recognizing a merchant's identity;
determining a return period for said at least one article of merchandise based on said merchant's return policy;
providing at least one alert associated with said return period.

18. The non-transitory computer readable medium of claim 17 wherein said steps are performed on a computing entity and said at least one alert is transmitted to another remote computing entity via a network.

19. The non-transitory computer readable medium of claim 18 wherein said receipt issued at a point of sale is transmitted to said computing entity for processing.

20. A device comprising:
a non-transitory computer readable medium having programmed instructions executable by a microprocessor to cause the microprocessor to process a receipt having data related to an item of merchandise, and extract said merchandise data;
a database having merchant data, said merchant data comprising said item of merchandise data and associated return policy data; and
a return reminder engine for receiving said merchandise data, merchant data and return policy data and determine a date of purchase and elapsed time post-purchase, and determine whether said item of merchandise is eligible for return based on said return policy data; and
providing at least one alert associated with said item of merchandise based on said return policy data.
